(19) United States
(12) Patent Application Publication
(10) Pub. No.: US 2014/0181346 A1
(43) Pub. Date: Jun. 26, 2014

(54) ASSEMBLY AND MANUFACTURE METHOD OF PRINTED CIRCUIT BOARD WITH SOLID MEMORY MODULE

(71) Applicant: HON HAI PRECISION INDUSTRY CO., LTD., New Taipei (TW)

(72) Inventors: CHIH-CHUNG SHIH, New Taipei (TW); LI-WEN CHANG, New Taipei (TW)

(21) Appl. No.: 13/922,682

(22) Filed: Jun. 20, 2013

(30) Foreign Application Priority Data
Dec. 24, 2012 (CN) 2012105666147

(51) Int. Cl. G06F 13/40

(52) U.S. Cl. CPC G06F 13/409
USPC 710/301

(57) ABSTRACT

An assembly includes a printed circuit board and a solid memory module. The printed circuit board defines a slot in a side surface of the printed circuit board, the slot has a bottom surface, and the printed circuit board defines a groove in the bottom surface and includes a number of contacts attached on an inner surface of the groove. The solid memory module includes a body identical to the slot in shape and size, a connection board corresponding to the groove and extending from a side of the body corresponding to the bottom surface, and a number of terminals of corresponding to the contacts and attached on an outer surface of the connection board. The body is inserted into the slot while the connection board is inserted into the groove and the contacts connect the terminals.

### BACKGROUND

1. Technical Field

The present disclosure relates to solid memory technologies and, more particularly, to an assembly and a manufacture method of a printed circuit board installed with a solid memory module.

2. Description of Related Art

One method to reduce a thickness of an assembly of a printed circuit board installed with a solid memory module is directly welding the solid memory module on the printed circuit board, however, the solid memory module can not be changed anymore for other desired storage capacities.

Therefore, it is desirable to provide an assembly and a manufacture method of a printed circuit board installed with a solid memory module, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a schematic planar view of an assembly of a printed circuit board with a solid memory module in accordance with an embodiment of the present disclosure.

FIG. 2 is a cross-sectional view taken alone a line II-II of FIG. 1

FIG. 3 is a flowchart of a manufacture method of the printed circuit board with the solid memory module of FIG. 1.

### DETAILED DESCRIPTION

Embodiments of the present disclosure will be described below with reference to the accompanying drawings.

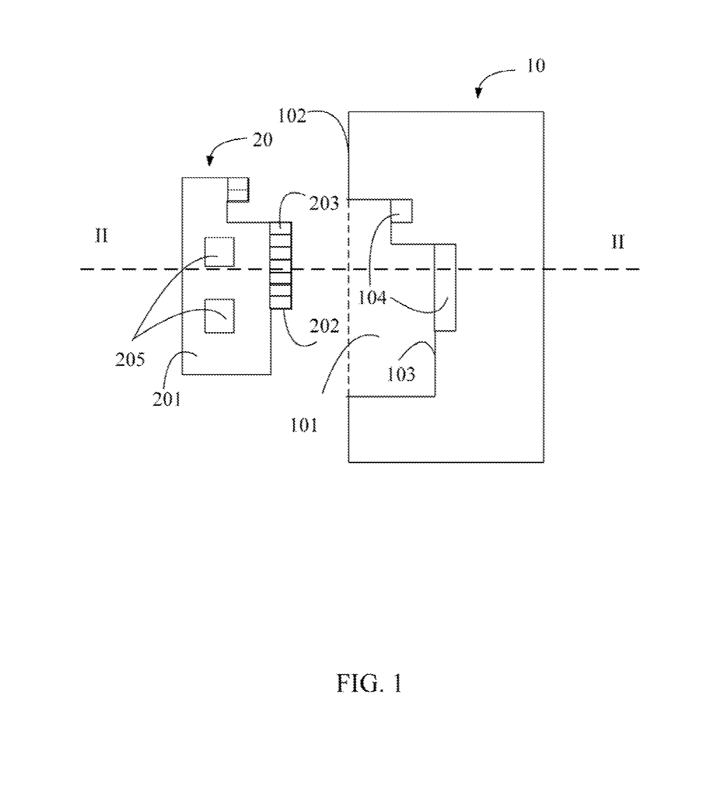

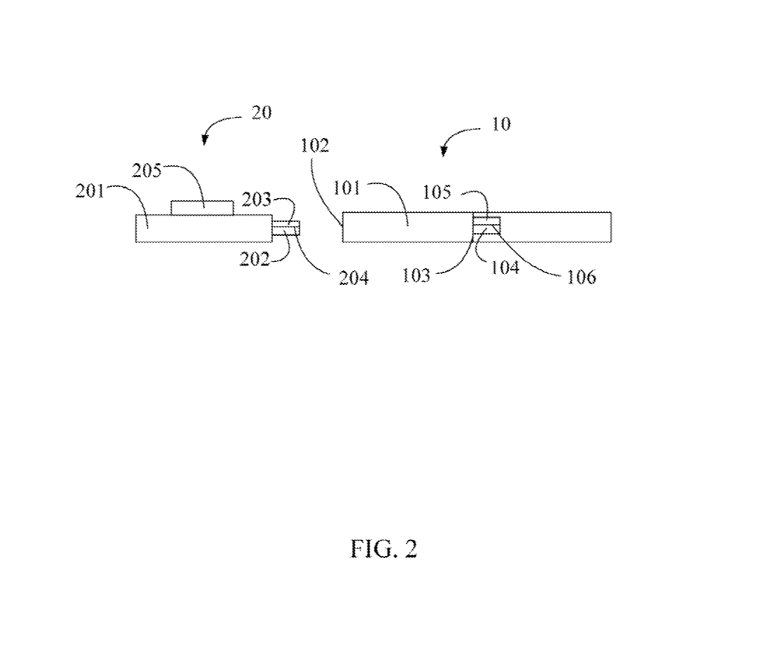

FIGS. 1 and 2 show an assembly of a printed circuit board 10, such as a computer motherboard, and a solid memory module 20 of an embodiment.

The printed circuit board 10 defines a slot 101 in a side surface 102. The slot 101 forms a bottom surface 103, which in this embodiment is, but in other embodiments is not limited to, a stepped surface. The printed circuit board 101 defines at least one, two in this embodiment, groove 104 in the bottom surface 102. The printed circuit board 101 also includes a number of contacts 105 attached to an inner surface 106 of each groove 104. The contacts 105 are in an electrical communication with circuits formed in the printed circuit board 10.

The solid memory module 20 includes a body 201, which is substantially identically to the slot 101 in shape and size. At least one connection board 202, corresponding to the at least one groove 103, extends to a side of the body 101 corresponding to the bottom surface 102. The solid memory module 20 includes a number of terminals 203 corresponding to the contacts 105 and attached to an outer surface 204 of the connection board 202. A sum of thicknesses of each contact 105, a corresponding terminal 203, and the connection board 202 is substantially equal to or slightly less than a thickness of the groove 104.

The solid memory module 20 also includes a number of chips 205, such as a main control chip and memory chips are attached to the body 201 and is in electrical communication with the terminals 203 via circuits formed in the solid memory module. Detailed structures of the solid memory module 20 can take reference to the copending U.S. patent application Ser. No. 13/271,803.

A total storage capacity of the solid memory module 20 depends on and can be changed by changing the number of the memory chips and a storage capacity of each memory chip. In addition, the connection board 202 and the terminals 203 cooperatively form a goldfinger while the groove 104 and the contacts 105 cooperatively form a receptacle of the goldfinger to allow a detachable connection between the printed circuit board 10 and the solid memory module 20. As such, the solid memory module 20 can be changed to for another desired total storage capacity if needed.

In other embodiments, the connection between the printed circuit board 10 and the solid memory module 20 can take other suitable forms depending on needs.

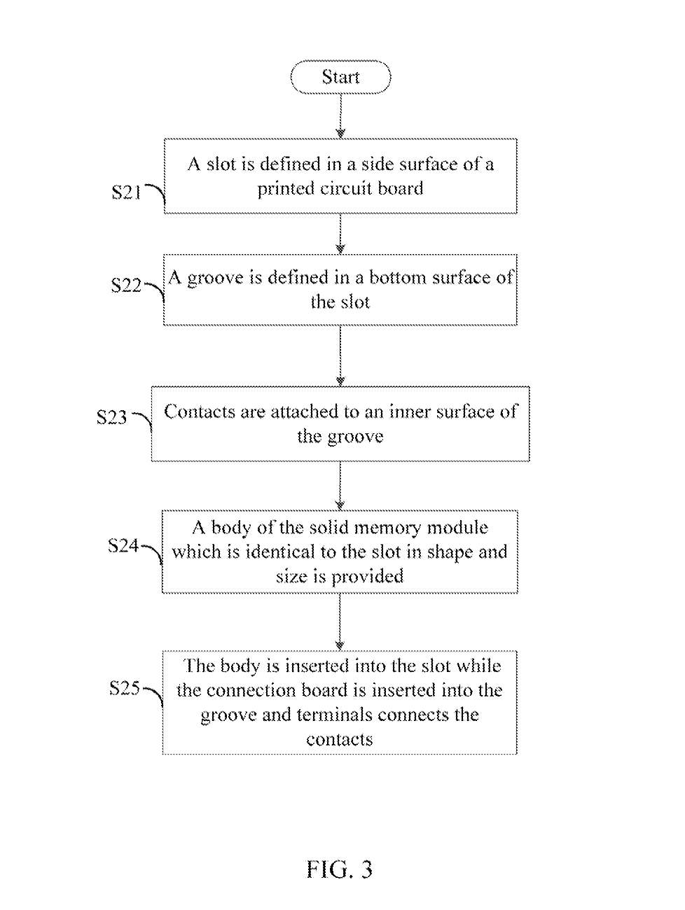

Referring to FIG. 3, a manufacture method of the printed circuit board 10 and the solid memory module 20 includes the following steps.

In step S21, the slot 101 is defined in the side surface of the printed circuit board 10.

In step S22, the groove 104 is defined in the bottom surface 103 of the slot 101.

In step S23, the contacts 105 are attached to the inner surface 106 of the groove 104.

In step S24, the body 201 of the solid memory module 20 which is identical to the slot 101 in shape and size is provided. The connection board 202 corresponding to the groove 104 is set on the side of the body 201 corresponding to the bottom surface 103. The terminals 203 corresponding to the contacts 105 are attached on the outer surface 204 of the connection board 202.

In step S25, the body 201 is inserted into the slot while the connection board 202 is inserted into the groove 104 and the terminals 203 connects the contacts 105.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A manufacture method a printed circuit board with a solid memory module comprising:
defining a slot in a side surface of the printed circuit board, the slot having a bottom surface;
defining a groove in the bottom surface;
attaching a plurality of contacts on an inner surface of the groove;
providing a body of the solid memory module to be identical to the slot in shape and size, a connection board of the solid memory module corresponding to the groove and extending from a side of the body corresponding to the bottom surface, and a plurality of terminals of the solid memory module corresponding to the contacts and attached on an outer surface of the connection board;
inserting the body into the slot while the connection board is inserted into the groove and the contacts connect the terminals.

2. The manufacture method of claim 1, wherein the solid memory module comprises a plurality of memory chips attached on the body, and a total storage capacity of the solid memory module is changed by changing the number of the memory chip and a storage capacity of each memory chip.

3. An assembly, comprising:
a printed circuit board defining a slot in a side surface of the printed circuit board, the slot having a bottom surface; the printed circuit board defining a groove in the bottom surface and comprising a plurality of contacts attached on an inner surface of the groove; and
a solid memory module comprising a body identical to the slot in shape and size, a connection board corresponding to the groove and extending from a side of the body corresponding to the bottom surface, and a plurality of terminals of corresponding to the contacts and attached on an outer surface of the connection board;
wherein the body is inserted into the slot while the connection board is inserted into the groove and the contacts connect the terminals.
